(19) United States
(12) Patent Application Publication
(10) Pub. No.: US 2025/0028623 A1
(43) Pub. Date: Jan. 23, 2025

(54) TECHNIQUES FOR MONITORING USAGE OF A DYNAMICALLY BOUND METHOD OF A SOFTWARE OBJECT

(71) Applicant: Sophos Limited, Abingdon (GB)

(72) Inventor: Tzu-yi Lin, Herndon, VA (US)

(21) Appl. No.: 18/222,829

(22) Filed: Jul. 17, 2023

(51) Int. Cl. G06F 11/36

(52) U.S. Cl. CPC G06F 11/3604

(57) ABSTRACT

In example embodiments, techniques are provided to monitor usage of a dynamically bound method (e.g., COM interface) of a software object (e.g., COM object). A copy of a virtual method table for the software object is created, wherein the virtual method table includes a method pointer to the dynamically bound method. The virtual method table is then modified to change the method pointer to an address of a hook function. In response to a call to the dynamically bound method, the hook function is called using the changed method pointer in the modified virtual method table. The hook function determines an address of the software object using a reference variable, uses the address of the software object to access the saved copy of the virtual method table, and calls the dynamically bound method using the method pointer from the saved copy of the virtual method table.

### BACKGROUND

### Technical Field

The present application relates generally to monitoring software object usage, and more specifically to monitoring usage of a dynamically bound method of a software object as part of, for example, the detection or investigation of malicious attacks.

### Background Information

As part of detecting or investigating a malicious attack on a compute instance caused by malware, viruses, spyware, or the like, it is often desirable to monitor the usage of software objects and their functions. Such monitoring may be performed via “hooking.” In this context, “hooking” refers to changing the default flow of execution by intercepting calls, messages, or events, and redirecting them to other code that may gather information, change results, or perform other operations. The other code that execution is redirected to is commonly referred to as a “hook function” or simply a “hook.”

It may be relatively straightforward to perform hooking in situations where the functions are exported and can be identified (i.e., located) using well-documented identifying functions. For example, it may be relatively straightforward to perform hooking of certain Windows® operating system application program interface (API) functions since these API functions are exported and can be located using the well-known GetProcAddress( ) function. Once the API function is identified, the function may be detoured to a hook. However, it may be more challenging to hook dynamically bound functions which are not exported and do not have well-documented identifying functions. For example, it may be more challenging to hook Component Object Model (COM) interface methods of COM objects.

COM is a platform-independent, distributed, object-oriented architecture for creating binary software components that can interact. The architecture follows an object model that revolves around COM objects and interfaces. COM objects may be within a single process, may be in multiple processes, may be remote, or otherwise arranged. Access to a COM object's data is achieved through one or more sets of related functions. These sets of related functions are typically referred to as “COM interfaces” or simply “interfaces,” and the functions of an interface are typically referred to as “COM interface methods” or simply “methods.” COM specifies use of a pointer to a COM interface to gain access to COM interface methods.

The structure of COM complicates hooking. First, identifying a COM interface method may be difficult. There typically is not a well-documented function that will simply provide the address of the COM interface method. Second, even after a COM interface method has been identified, one typically cannot just detour it to a hook based on its address. The underlying function may be shared between multiple COM objects. Accordingly, to properly detour the function to a hook one would typically need to know which COM object invoked it.

One traditional approach for monitoring dynamically bound methods of software objects is to create a wrapper around the software object whose methods are to be monitored (e.g., a wrapper COM object around the COM object whose COM interface methods are to be monitored). However, this may be highly inefficient as the wrapper typically needs to implement all the methods of the software object, not just those of interest. For example, if the software object includes 20 methods, the wrapper software object would need to implement 20 methods, even if only one of those methods were of interest.

Accordingly, there is a need for improved techniques to monitor usage of a dynamically bound method (e.g., a COM interface method) of a software object (e.g., a COM object), for example, as part of detecting or investigating a malicious attack on a compute instance.

### SUMMARY

In various example embodiments, improved techniques are provided to monitor usage of a dynamically bound method (e.g., a COM interface method) of a software object (e.g., a COM object). A copy may be made of a virtual function table of the software object whose dynamically bound method is to be monitored. The original virtual method table may then be modified to change a method pointer to the dynamically bound method to an address of a hook function. When a call is made to the dynamically bound method, the hook function may instead be called using the changed method pointer in the modified virtual method table. The hook function may perform operations, for example, monitoring operations to record parameters of the call to the dynamically bound method, and then invoke the dynamically bound method. This may be done by determining the address of the software object using a reference variable (e.g., a C++ this keyword) that refers to a current object of the dynamically bound method as a parameter, using the address of the software object to access the saved copy of the virtual method table, and calling the dynamically bound method using the method pointer from the saved copy of the virtual method table. In contrast to a traditional approach which requires creating a wrapper implementing all methods of the software object, the improved techniques may advantageously only affect a selected subset of the dynamically bound methods the software object offers. For methods whose usage is not to be monitored, the modified virtual method table may simply retain the original method pointer, so their call is not affected.

In one example embodiment, a method is provided for monitoring usage of a dynamically bound method of a software object. A copy of a virtual method table for the software object is saved to a memory of a computing device, wherein the virtual method table includes a method pointer to the dynamically bound method. The computing device modifies the virtual method table to change the method pointer to an address of a hook function. In response to a call on the computing device to the dynamically bound method, the hook function is called using the changed method pointer in the modified virtual method table. The hook function determines an address of the software object using a reference variable that refers to a current object of the dynamically bound method as a parameter, uses the address of the software object to access the saved copy of the virtual method table, and calls the dynamically bound method using the method pointer from the saved copy of the virtual method table.

In another example embodiment, an apparatus is provided for monitoring usage of a dynamically bound method of a software object. The apparatus includes one or more processors configured to execute software and one or more memories coupled to the one or more processors. The one or more memories are configured to store software of a hooking process and a hook function. The hooking process, when executed on the one or more processors, is operable to save a copy of a virtual method table for the software object, wherein the virtual method table includes a method pointer to the dynamically bound method, and to modify the virtual method table to change the method pointer to an address of the hook function. The hook function, when executed on the one or more processors, in response to being called via the changed method pointer in the modified virtual method table, is operable to determine an address of the software object using a reference variable that refers to a current object of the dynamically bound method as a parameter, use the address of the software object to access the saved copy of the virtual method table, call the dynamically bound method using the method pointer from the saved copy of the virtual method table, record one or more parameters of the call to the dynamically bound method, and provide the one or more parameters to a threat management facility.

In yet another example embodiment, a non-transitory computer readable medium is provided having software encoded thereon. The software when executed by one or more computing devices is operable to modify an original virtual method table for a software object that includes a method pointer to a dynamically bound method to create a modified virtual method table in which the method pointer points to a hook function. In response to a call to the dynamically bound method, the software is further operable to call the hook function using the method pointer in the modified virtual method table, determine an address of the software object using a reference variable that refers to a current object of the dynamically bound method as a parameter, use the address of the software object to access the original virtual method table, and call the dynamically bound method using the method pointer from the original virtual method table.

It should be understood that a wide variety of additional features and alternative embodiments may be implemented other than those discussed in this Summary. This Summary is intended simply as a brief introduction to the reader for the further description that follows and does not indicate or imply that the examples mentioned herein cover all aspects of the disclosure or are necessary or essential aspects of the disclosure.

### BRIEF DESCRIPTION OF THE DRAWINGS

The description below refers to the accompanying drawings of example embodiments, of which:

FIG. 1 is a block diagram of an example threat management system in which a threat management facility may be used to detect and investigate malicious attacks, including attacks performed by malware, viruses, spyware, intrusions, and the like;

FIG. 2 is a block diagram of a portion of an example threat management system focusing on deployment of a security agent on a compute instance, in this example a computing device such as an endpoint;

FIG. 3 is a diagram showing the arrangement of an example interface (e.g., COM interface) of a software object (e.g., a COM object) that may be used to access its dynamically bound methods (e.g., COM interface methods);

FIG. 4 is a diagram illustrating example operations that may be performed upon the arrangement of FIG. 3 to hook one or more selected dynamically bound methods (e.g., COM interface methods) of a software object (e.g., a COM object);

FIG. 5 is a listing of example commands that include calls to dynamically bound methods (e.g., COM interface methods) and example parameters and/or other details that may be recorded by a hook function; and

FIG. 6 is a flow diagram of an example sequence of steps that may implement improved techniques for monitoring usage of a dynamically bound method (e.g., COM interface method) of a software object (e.g., a COM object).

### DETAILED DESCRIPTION

The following detailed description describes example embodiments. Any documents mentioned herein should be considered to be incorporated by reference in their entirety. Any references to items in the singular should be understood to include items in the plural, and vice versa, unless explicitly stated otherwise or otherwise clear from the context. Grammatical conjunctions are generally intended to express any and all disjunctive and conjunctive combinations of conjoined clauses, sentences, words, and the like, unless otherwise stated or clear from the context. For example, the term “or” should generally be understood to mean “and/or.”

Any recitation of ranges of values are not intended to be limiting, are provided as example only, and are not intended to constitute a limitation on the scope of the described embodiments. Further, any recitation of ranges should be interpreted as referring individually to any and all values falling within the range, unless otherwise indicated, and each separate value within such a range should be treated as if it were individually recited. Terms of approximation such as “about,” “approximately,” “substantially” or the like, should be construed as referring to an allowance for deviation that is appreciated by one of ordinary skill in the art to still permit satisfactory operation for the corresponding use, function, purpose, or the like. No language in the description should be construed as indicating that an element is a necessary or essential aspect of the disclosure. Further, terms such as “first,” “second,” “top,” “bottom,” “up,” “down,” and the like, should be considered to be words of convenience and do not preclude differing orderings or orientations.

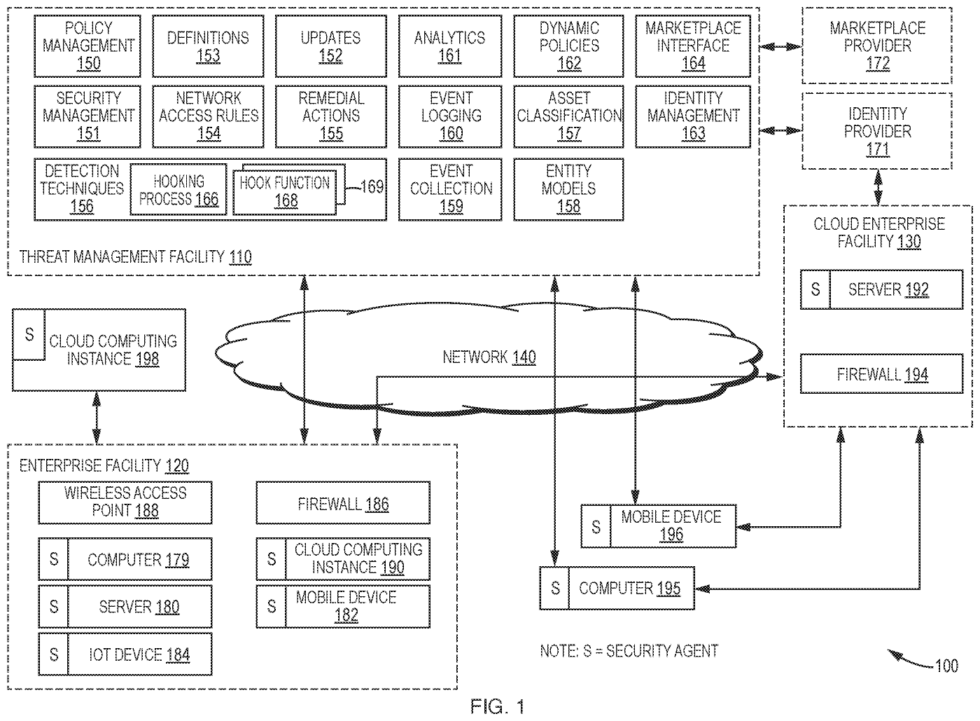

FIG. 1 is a block diagram of an example threat management system 100 in which a threat management facility 110 may be used to detect and investigate malicious attacks, including attacks performed by malware, viruses, spyware, intrusions, and the like. The threat management facility 110 may communicate with, coordinate, and control operation of security functionality of compute instances and networks within an enterprise facility 120, cloud enterprise facility 130, or external to such facilities 120, 130. As used herein, the term “compute instance” refers to a computing device (e.g., an endpoint, network device, or sub-component thereof) that can run software code, or a virtual machine (e.g., a cloud computing instance) executing on a computing device (e.g., a cloud-based or local server) that can execute software code. In this context, being “within” a facility 120, 130 refers to being on the local area network (LAN) of the facility 120, 130 (e.g., inside the gateway) or being more generally associated with the facility 120, 130 (e.g., outside the gateway but nonetheless managed by, or in communication with, devices of the facility). An overall goal of the threat management facility 110 may be to intelligently use the breadth and depth of information that is available to it via the security agents and other connected software to detect and investigate threats to the compute instances and networks within the enterprise facility 120, cloud enterprise facility 130, and external to such facilities 120, 130.

Looking to the threat management facility 110 in more detail, the facility 110 may include a number of sub-facilities (in this context, typically processes or daemons that perform discrete functions) such as a policy management facility 150, security management facility 151, update facility 152, definitions facility 153, network access rules facility 154, remedial actions facility 155, detection techniques facility 156, asset classification facility 157, entity model facility 158, event collection facility 159, event logging facility 160, analytics facility 161, dynamic policies facility 162, identity management facility 163, marketplace interface facility 164, as well as other facilities. The threat management facility 110 and its sub-facilities 150-164 may be executed, in whole or in part, on compute instances in a single or different locations. For example, some portion of the threat management facility 110 or its sub-facilities 150-164 may be executed on a cloud platform that includes cloud-based servers or other cloud-based computing devices, while other portions may be executed on endpoints, network devices or virtual machines of an enterprise facility 120 or cloud enterprise facility 130, or external to such facilities 120, 130. In the latter case, the threat management facility 110 or its sub-facilities 150-164 may be integrated into (e.g., deployed in) a security agent S that is executed by a compute instance (or in some cases physical hardware of a compute instance) of an enterprise facility 120 or cloud enterprise facility 130, or external to such facilities 120, 130. Accordingly, while FIG. 1 shows the threat management facility 110 and its sub-facilities 150-164 as separate from the endpoints, network devices and virtual machines of an enterprise facility 120 or cloud enterprise facility 130, or endpoints, network devices and virtual machines external to such facilities 120, 130, it should be understood that such separation is merely to permit visual representation.

Each facility 150-164 may provide a respective function to collectively detect and investigate threats. The policy management facility 150 may manage rules or policies, for example, access permissions for networks, applications, compute instances, users, data, and the like. The security management facility 151 may provide malicious code protection, email security and control, web security and control, network access control, host intrusion prevention, reputation filtering, as well as other functions. The update management facility 153 may provide control over when updates are performed, for example, receiving updates from a provider, and distributing the updates to compute instances and networks. The network access rules facility 154 may provide access restrictions to applications, networks, endpoints, data, users, etc. under direction of network access policies from the policy management facility 150 or other sources. The remedial actions facility 155 may perform measures to address a threat or policy violation detected by another facility, such as collecting additional data to enable further response, terminating or modifying an ongoing process or interaction, sending a warning to a user or administrator, downloading a remediation data file with commands, definitions, instructions, or the like to execute, executing a remediation program or application, quarantining an entity or device, blocking access to resources, etc. The detection techniques facility 156 may provide particular threat detection and investigation techniques used by the security management facility 151 and other facilities. As described in more detail below, the detection techniques facility 156 may include among its functionality a hooking process 166 and hook functions 168, 169 that may be deployed to monitor usage of one or more dynamically bound methods (e.g., COM interface methods) of a software object (e.g., a COM object). The hook functions 168, 169 may be implemented as member functions of a C++ class.

The asset classification facility 157 may provide an asset discovery service to determine assets present in the enterprise facility 120, cloud enterprise facility 130, or external to such facilities 120, 130. As used herein, the term “asset” refers to data, a device, or other component that supports information-related activities. Assets are typically organized in an asset stack, where a first level asset is physical hardware. A compute instance may be, or may be implemented on, a first level asset.

The entity models facility 158 may determine the events that are generated by assets, for example, from process/usage information provided by an operating system, from activity information from containers, etc. The event collection facility 159 may identify the occurrence of particular events based on information from sensors that monitor assets, for example, sensors that monitor streaming data through network devices, monitor activity of compute instances, monitor stored files/data on compute instances, etc. The event logging facility 160 may store (e.g., locally and/or in cloud-based storage) events collected by the event classification facility 157 so that they can be accessed and analyzed. The analytics facility 161 may make inferences and observations about the events, as part of policies enforced by the security management facility 151 or other facilities, which may be stored by the event logging facility 160. The dynamic policies facility 162 may generate policies dynamically based on observations and inferences made by the analytics facility 161 that may be provided to the policy management facility 150 and enforced by the security management facility 151.

The identity management facility 163 may operate in conjunction with a remote identity provider 171 to confirm identity of a user as well as to provide or receive other information about users that may be useful to protect against threats. Among other functionality, the identity management facility 163 may communicate hygiene or security risk information to the identity provider 171. The identity provider 171 may determine a risk score for a user based on the events, observations, and inferences about that user and compute instances associated with the user, and take steps to address any potential risk. The marketplace interface facility 164 may operate in conjunction with a marketplace provider 172 (e.g., a physical security event provider, a human resources system provider, a fraud detection system provider, etc.) to provide additional functionality or capabilities to the threat management facility 110. The interface facility 164 may provide notifications of events to the marketplace provider 172, which in turn may analyze the events and return inferences that may be used by the analytics facility 161 and/or the security management facility 151.

Looking to the enterprise facility 120 in more detail, it should be understood that the enterprise facility 120 includes a collection of networked computer-based infrastructure. For example, the enterprise facility 120 may be a corporate, commercial, organizational, educational, or governmental computer network. Likewise, as home networks are becoming more complex, the enterprise facility 120 may alternatively be a home network or a network that covers a group of homes. The enterprise facility 120 may include a number of compute instances, including endpoints, network devices and virtual machines. The endpoints and network devices may be distributed amongst a plurality of physical premises, such as buildings, and may be located in one or in a number of geographical locations. Each may take a variety of different forms. For example, endpoints may be individual computers 179, servers 180, mobile devices 182, Internet appliances or Internet-of-Things (IoT) devices 184 or other physical devices that connect to and exchange information with a network. The network devices may include firewalls 186, wireless access points 188, gateways, bridges or other physical devices that are required for communication and interaction between hardware on a network. The virtual machines may include cloud computing instances 190 or other computing environments created by abstracting resources from a physical device. The virtual machines may be executed on hardware distributed amongst a plurality of physical premises, for example, local servers, remote servers, cloud-based servers of a cloud platform, etc. In general, it should be understood that that the compute instances shown in FIG. 1 of the enterprise facility 120 are merely examples, and that the compute instances of an enterprise facility 120 may include a wide variety of types of endpoints, network devices and virtual machines.

Looking to the cloud enterprise facility 130 in more detail, it should be understood that the cloud enterprise facility 120 includes a collection of cloud-based infrastructure. The cloud enterprise facility 120 may provide software as a service (Saas), platform as a service (PaaS), Infrastructure as a Service (IaaS) or other cloud computing functions to compute instances and networks within the enterprise facility 120 or external to such facility. The cloud enterprise facility 120 may include a number of compute instances, including endpoints, network devices and virtual machines. For example, the cloud enterprise facility 130 may include servers 192, firewalls 194, as well as other physical devices. Likewise, the cloud enterprise facility 130 may include a number of cloud computing instances 190 or other computing environments. It should be understood that the compute instances shown in FIG. 1 inside the cloud enterprise facility 130 are merely examples and that the compute instances of a cloud enterprise facility 130 may include a wide variety of types of endpoints, network devices and virtual machines.

Looking to the compute instances and networks external to the enterprise facility 120 and cloud enterprise facility 130 in more detail, it should be understood that the external compute instances may similarly include a number of endpoints, network devices, virtual machines, and the like. For example, the external compute instances may include individual computers 195, mobile devices 196 and cloud computing instances 198 as well as other physical devices or virtual machines. The external compute instances may use network connectivity not directly associated with or controlled by the enterprise facility 120 or the cloud enterprise facility 130, for example, a mobile network, a public cloud network, a wireless network of a hotel or coffee shop, etc. The external compute instances may utilize the threat management facility 110 even though they are outside the enterprise facility 120 or the cloud enterprise facility 130.

The compute instances of the enterprise facility 120, cloud enterprise facility 130, or external to such facilities 120, 130 may communicate with each other, cloud based portions of the threat management facility 110, and other cloud based platforms (not shown) that provide SaaS or other services independent of the facilities 120, 130, with unprotected servers (not shown) that host websites, and the like, via a network 140, such as the Internet, or other public or private network.

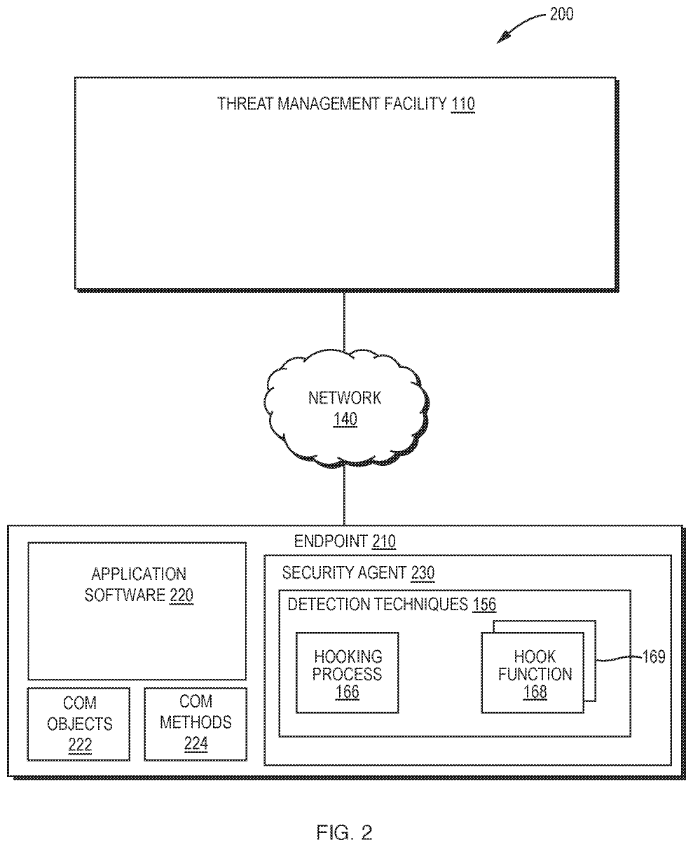

FIG. 2 is a block diagram of a portion of an example threat management system 200 focusing on deployment of a security agent on a compute instance, in this example, a computing device such as an endpoint 210. It should be understood that the deployment shown in FIG. 2 may be similarly applicable to other types of compute instances, including other types of computing devices such as network devices or virtual machines. The endpoint 210 may include a memory/storage device and a processor that maintain and execute, respectively, application software 220 that provides functionality to the endpoint 210 and software of a security agent 230 that supports threat detection and investigation on the endpoint 210. Application software 220 may include operating system software, application software, middleware, and other types of software. At least some of the application software may utilize software objects (e.g., COM objects) 222 that include dynamically bound methods (e.g., COM interface methods) 224. As discussed in more detail below, the application software 220 may reference the software objects (e.g., COM objects) 222 via an interface (e.g., a COM interface) in order to use their dynamically bound methods (e.g., COM interface methods) 224.

The security agent 220 may include at least portions of the sub-facilities 150-164 of the threat management facility 110. As discussed in more detail below, these portions may include the hooking process 166 and hook functions 168, 169 of the threat detection techniques facility 156, which include functionality to monitor usage of dynamically bound methods of software object. While portions of other sub-facilities 150-154, 158-164 of the threat management facility 110 are not shown in FIG. 2, it should be understood that some or all of any such sub-facilities may be disposed on the endpoint 210. Likewise, the security agent 220 may communicate via the network 140 (e.g., the Internet) with portions of the sub-facilities 150-164 of the threat management facility 110 that are executed on a cloud platform. Accordingly, it should be understood that, in general, functionality may often be arranged in various locations.

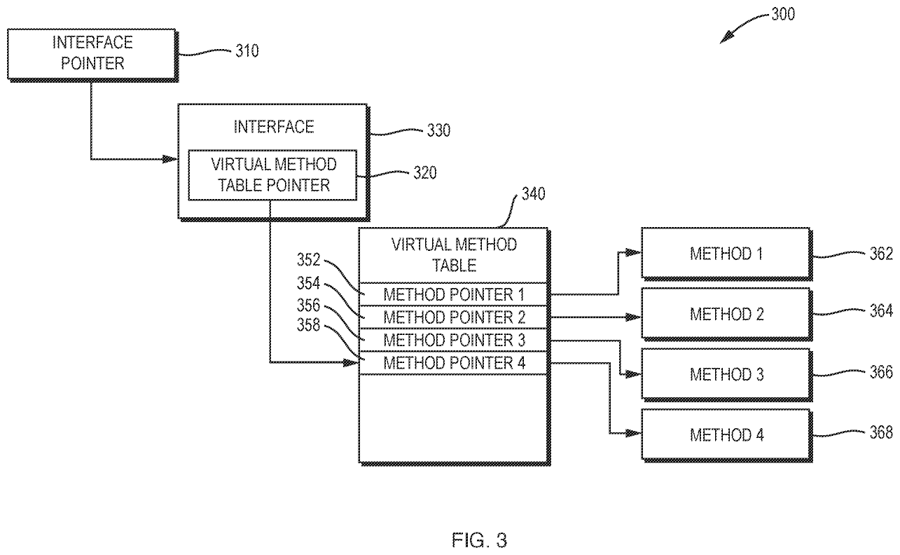

FIG. 3 is a diagram 300 showing the arrangement of an example interface (e.g., COM interface) of a software object (e.g., COM object) that may be used to access its dynamically bound methods (e.g., COM interface methods). From the perspective of application software (i.e., from a client's perspective) a reference to the interface (e.g., COM interface) 330 is a pointer to a pointer to a table of pointers to functions. That is, the application software holds an interface pointer 310 to a virtual method table pointer 320 to a virtual method table 340 that includes method pointers 352-358 to the interface's dynamically bound methods (e.g., COM interface methods) 362-368. The virtual method table pointer 320 may be part of a larger data structure that maintains state of the object. However, typically only the virtual method table pointer 320 is visible to the application software (e.g., client). To call one of the dynamically bound methods 362-368 the application software (e.g., client) follows the interface pointer 310 to the virtual method table pointer 320, dereferences the virtual method table pointer 320 to find the virtual method table 340, looks up the appropriate method pointer 352-358 in virtual method table 340, and then uses the appropriate method pointer 352-358 to call the appropriate method 362-368. The method 362-368 may take as a parameter a copy of the original interface pointer 310, allowing it to locate state of the object from the larger data structure.

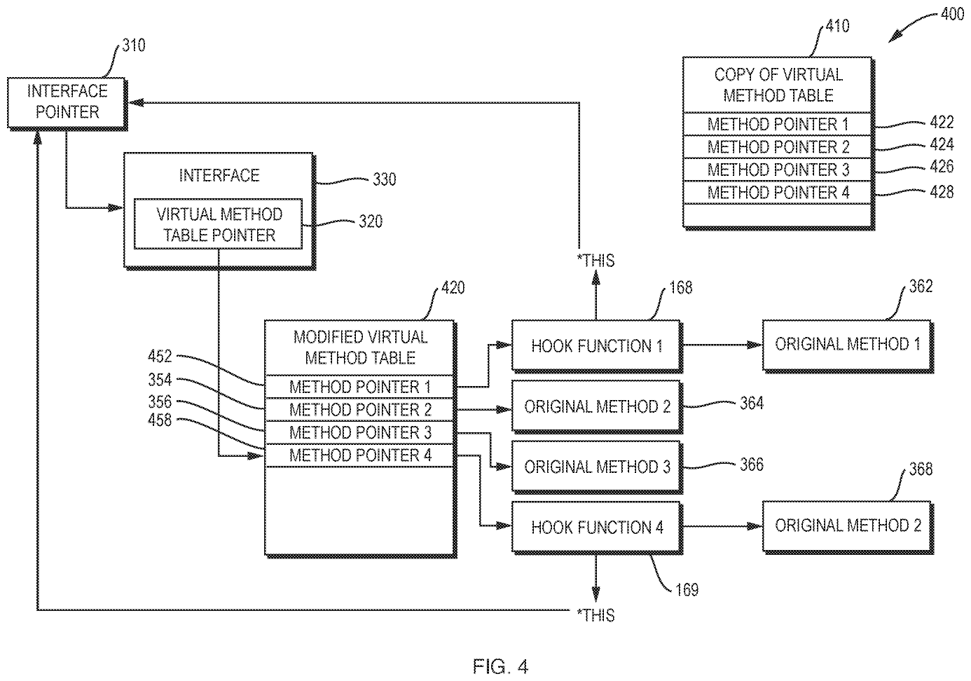

According to embodiments described herein, the hooking process 166 may implement improved techniques that may build upon the arrangement of FIG. 3 to facilitate usage monitoring of one or more selected dynamically bound methods (e.g., COM interface methods) 362-368. FIG. 4 is a diagram 400 illustrating example operations that may be performed upon the arrangement of FIG. 3 to hook one or more selected dynamically bound methods (e.g., COM interface methods) 362-368 of a software object (e.g., COM object). The hooking process 166 may initially make a copy 410 of the virtual method table 340 having copied method pointers 422-428, for example by storing the original address of the virtual method table and each original function address in association with the address of the software object (e.g., COM object). The hooking process 166 may then modify original virtual method table to change the method pointer of one or more selected dynamically bound methods (e.g., COM interface methods) to an address of a hook function 168,169, thereby producing a modified virtual method table 420 with modified method pointers 452, 458. For instance, in the example shown in FIG. 4, the first method pointer is changed to the address of a first hook function 168 as indicated by modified method pointer 452 and the fourth method pointer is changed to the address of a second hook function 169 as indicated by modified method pointer 458. The second method pointer is maintained unchanged and still stores the address of the original second dynamically bound method (e.g., COM interface method) 364 as indicated by original method pointer 354 and the third method pointer 356 is maintained unchanged and still stores the address of the original third dynamically bound method (e.g., COM interface method) 366 as indicated by original method pointer 356.

One issue confronted is how to determine the address of the hook function 168, 169 for the modified method pointer 452, 458. In one embodiment, the hooking process 166 may determine the address by, for example, by creating an additional software object (e.g., a C++ object) that includes the hook function 168, 169, and reading the address of the hook function from the additional virtual method table.

As a result of the modified method pointers 452, 458 in the modified virtual method table 420, when application software (e.g., a client) attempts to call one of the selected dynamically bound methods 362, 368, the respective hook function 168, 169 is called instead. That is, the application software (e.g., client) follows the interface pointer 310 to the virtual method table pointer 320, dereferences the virtual method table pointer 320 to find the modified virtual method table 420, looks up the modified method pointer 452, 458 in modified virtual method table 420, and then uses the modified method pointer 452, 458 to reach the hook function 168, 169. For the non-selected dynamically bound methods 364, 366, the original dynamically bound methods (e.g., COM interface methods) are reached as normal, via the original method pointers 354, 356.

When called, a hook function 168, 169 may perform a variety of operations. For example, a hook function 168, 169 may record parameters and/or other details of the call to the dynamically bound method. The hook function 168, 169 may provide this information to the hooking process 166 of the detection techniques facility 156, to other sub-facilities 150-164 of the threat management facility 110, or to other software, for use in detecting and investigating malicious attacks, or for other purposes. Likewise, it should be understood that the hook function 168, 169 may additionally or alternatively perform other functions, including modifying parameters, pausing execution, interacting with other software, and the like.

A hook function 168, 169 may also invoke the original dynamically bound method (original COM interface method) 362, 368. When the hook function 168, 169 is called, a parameter (e.g., the first parameter) may be a reference variable that refers to the current object of the dynamically bound method. In one embodiment, where the hook function 168, 169 is implemented as a member function of a C++ class, the reference variable may be a C++ this keyword. Using the reference variable (e.g., the C++ this keyword) the address of the software object (e.g., COM object) may be determined and the copy of the of the virtual method table 410 having copied method pointers 422-428 located. A hook function 168, 169 may look up the original method pointer 422, 428 in the copy of the virtual method table 410, and then use the appropriate method pointer 422, 428 to call the original method 362, 368.

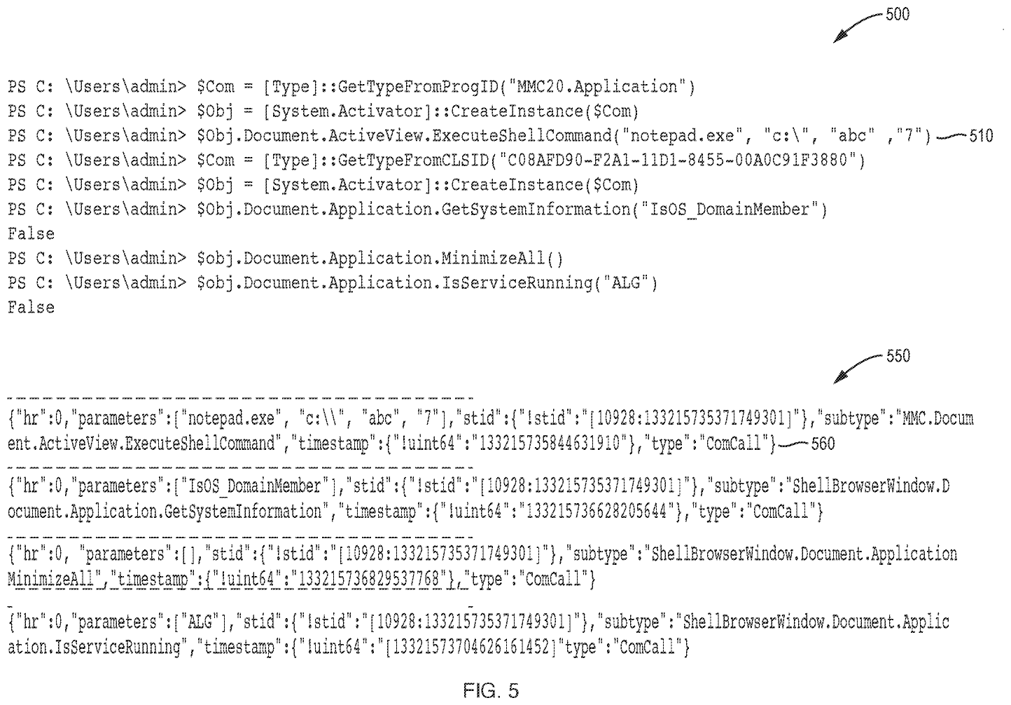

FIG. 5 is a listing 500 of example commands that include calls to dynamically bound methods (e.g., COM interface methods) and example parameters and/or other details 550 that may be recorded by a hook function 168, 169. While this example shows the calls as part of commands entered manually into a command-line shell (e.g., the Powershell™ task automation and configuration management program), it should be understood that similar calls may be made without direct user intervention by application software (e.g., clients). Likewise, while this example shows the parameters and/or other details recorded by the hook function 168, 169 displayed in a user interface, it should be understood that the details may be provided to other software (e.g., to sub-facilities 150-164 of the threat management facility 110) without display.

By way of illustration, consider the “ExecuteShellCommand” method 510 in listing 500 which executes a command in a window. The command includes four parameters “notepad.exe,” “c:\,” “abc” and “7”. As shown in line 560 of the recorded details, the hook function 168, 169 may record these parameters, as well as additional details, in response to the method being called.

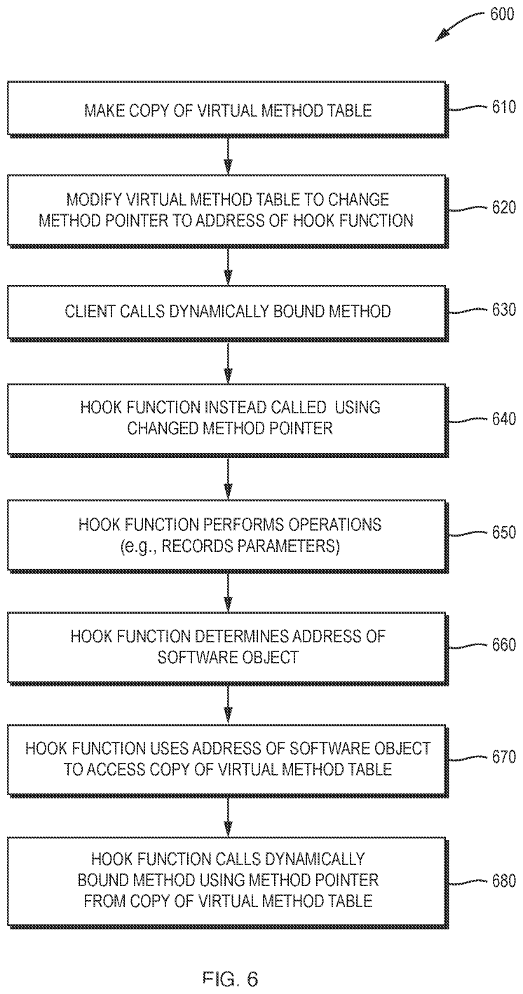

FIG. 6 is a flow diagram of an example sequence of steps 600 that may implement improved techniques for monitoring usage of a dynamically bound method (e.g., COM interface method) of a software object (e.g., a COM object). Such sequence of steps may summarize operations that are introduced above in connection with FIG. 4. At step 610, the hooking process 166 makes a copy of a virtual method table for a software object, wherein the virtual method table includes a method pointer to a dynamically bound method that is to be monitored. At step 620, the hooking process 166 modifies the virtual method table to change the method pointer to an address of a hook function 168, 169. At step 630, which may occur at a subsequent time to step 620, a call is made by application software (e.g., a client) to the dynamically bound method. At step 640, in response to the call from the application software (e.g., client), the hook function 168, 169 is instead called using the changed method pointer in the modified virtual method table. At step 650, the hook function 168, 169 performs operations, for example, monitoring operations to record parameters of the call to the dynamically bound method. At step 660, the hook function 168, 169 determines an address of the software object, for example, using a reference variable (e.g., a C++ this keyword) that resolves to an address of the software object. At step 670, the hook function 168, 169 uses the address of the software object to access the saved copy of the virtual method table. At step 680, the hook function 168, 169 calls the dynamically bound method using the method pointer from the saved copy of the virtual method table.

In conclusion, the above description describes various example techniques for monitoring usage of a dynamically bound method of a software object as part of, for example, the detection or investigation of malicious attacks. The techniques may provide a number of advantages. For example, in contrast to a traditional approach that requires creating a wrapper implementing all methods of the software object, the techniques may allow hooking of a selected subset of dynamically bound methods without affecting other methods. This may increase resource utilization efficiency (e.g., in terms of processing or memory consumption) to improve the operation of compute instances, as well as to provide other benefits.

It should be understood that a wide variety of adaptations and modifications may be made to the techniques to suit various implementations and environments. While it is discussed above that aspects of the techniques can be implemented by specific software executing on specific hardware, it should be understood that the techniques may also be implemented by different software, different hardware, or various different combinations thereof that are suitable for a particular environment. Software may include instructions in a high-level programming language (e.g., C++) or low-level programming language (e.g., assembly language, hardware description language, database programming language, etc.) that may be stored, and compiled or interpreted to run on hardware. For example, instructions may be stored on a non-transitory computing-device readable medium that when executed on one or more processors are operable to perform the above techniques.

While it is discussed above that certain portions of the techniques can be arranged or distributed in certain ways, it should be understood a wide variety of other arrangements are also possible, and that portions of the techniques may be distributed across software, hardware, or combinations thereof in a wide variety of other manners. For example, functionality may be distributed across any of the devices or systems described above, or all of the functionality may be integrated into a single device or system. Likewise, means for performing any steps described above may include any of the hardware and/or software described above. All such permutations and combinations are intended to fall within the scope of the present disclosure.

It should be understood that the ordering of any method steps discussed above may be changed to suit various applications or requirements. Absent an explicit indication to the contrary, the order of steps described above may be modified such that a subsequent step occurs before a preceding step, or in parallel to such step.

Above all, it should be understood that the above descriptions are meant to be taken only by way of example. Numerous variations, additions, omissions, and other modifications will be apparent to one of ordinary skill in the art, and such variations, additions, omissions, and other modifications should be considered within the scope of this disclosure. Thus, while example embodiments have been shown and described, it will be apparent to those skilled in the art that changes and modifications may be made therein without departing from the spirit and scope of this disclosure.

What is claimed is:

1. A method for monitoring usage of a dynamically bound method of a software object, comprising:
saving, to a memory of a computing device, a copy of a virtual method table for the software object, wherein the virtual method table includes a method pointer to the dynamically bound method;
modifying, by the computing device, the virtual method table to change the method pointer to an address of a hook function; and
in response to a call on the computing device to the dynamically bound method,
calling the hook function using the changed method pointer in the modified virtual method table,
determining, by the hook function, an address of the software object using a reference variable that refers to a current object of the dynamically bound method as a parameter,
using the address of the software object to access the saved copy of the virtual method table, and
calling the dynamically bound method using the method pointer from the saved copy of the virtual method table.

2. The method of claim 1, further comprising:
recording, by the hook function, one or more parameters of the call to the dynamically bound method; and
providing the one or more parameters to a threat management facility.

3. The method of claim 1, wherein the software object is a Component Object Model (COM) object, and the dynamically bound method is a COM interface method of the COM object.

4. The method of claim 1, further comprising:
determining an address of the hook function for the changed method pointer by,
creating an additional software object that includes the hook function, the additional software object having an additional virtual method table, and
reading the address of the hook function from the additional virtual method table.

5. The method of claim 4, wherein the additional software object is a C++ object.

6. The method of claim 1, wherein the hook function is a member function of a C++ class and the reference variable is a C++ this keyword that returns the address of the current object of the dynamically bound method.

7. The method of claim 1, wherein the software object includes a plurality of dynamically bound methods, and the modified virtual method table retains a method pointer to at least one other dynamically bound method whose usage is not monitored.

8. The method of claim 1, wherein the software object includes an interface pointer to an interface, and the interface includes a virtual method table pointer to the virtual method table

9. An apparatus for monitoring usage of a dynamically bound method of a software object, comprising:
one or more processors configured to execute software; and
one or more memories coupled to the one or more processors, the one or more memories configured to store software of a hooking process and a hook function, wherein the hooking process when executed on the one or more processors is operable to:
save a copy of a virtual method table for the software object, wherein the virtual method table includes a method pointer to the dynamically bound method, and
modify the virtual method table to change the method pointer to an address of the hook function, and
wherein the hook function when executed on the one or more processors in response to being called via the changed method pointer in the modified virtual method table is operable to:
determine an address of the software object using a reference variable that refers to a current object of the dynamically bound method as a parameter,
use the address of the software object to access the saved copy of the virtual method table,
call the dynamically bound method using the method pointer from the saved copy of the virtual method table,
record one or more parameters of the call to the dynamically bound method, and
provide the one or more parameters to a threat management facility.

10. The apparatus of claim 9, wherein the hook function is a member function of a C++ class and the reference variable is a C++ this keyword that returns the address of the current object of the dynamically bound method.

11. The apparatus of claim 9, wherein the software object is a Component Object Model (COM) object, and the dynamically bound method is a COM interface method of the COM object.

12. The apparatus of claim 9, wherein the hooking process when executed is further operable to:
determine an address of the hook function for the changed method pointer by,
creating an additional software object that includes the hook function, the additional software object having an additional virtual method table, and
reading the address of the hook function from the virtual method table.

13. The apparatus of claim 12, wherein the additional software object is a C++ object.

14. A non-transitory computer readable medium having software encoded thereon, the software when executed by one or more computing devices operable to:
modify an original virtual method table for a software object that includes a method pointer to a dynamically bound method to create a modified virtual method table in which the method pointer points to a hook function; and
in response to a call to the dynamically bound method,
call the hook function using the method pointer in the modified virtual method table,
determine an address of the software object using a reference variable that refers to a current object of the dynamically bound method as a parameter,
use the address of the software object to access the original virtual method table, and
call the dynamically bound method using the method pointer from the original virtual method table.

15. The non-transitory computer readable medium of claim 14, wherein the software when executed is further operable to:
record one or more parameters of the call to the dynamically bound method; and
provide the one or more parameters to a threat management facility.

16. The non-transitory computer readable medium of claim 14, wherein the software object is a Component Object Model (COM) object, and the dynamically bound method is a COM interface method of the COM object.

17. The non-transitory computer readable medium of claim 14, wherein the software when executed is further operable to:
determine an address of the hook function for the changed method pointer by,
creating an additional software object that includes the hook function, the additional software object having an additional virtual method table, and
reading the address of the hook function from the virtual method table.

18. The non-transitory computer readable medium of claim 17, wherein the additional software object is a C++ object.

19. The non-transitory computer readable medium of claim 14, wherein the hook function is a member function of a C++ class and the reference variable is a C++ this keyword that returns the address of the current object of the dynamically bound method.

20. The non-transitory computer readable medium of claim 14, wherein the software object includes a plurality of dynamically bound methods, and the modified virtual method table retains a method pointer to at least one other dynamically bound method whose usage is not monitored.
